(19) United States
(12) Patent Application Publication
(10) Pub. No.: US 2008/0056512 A1
(43) Pub. Date: Mar. 6, 2008

(54) SWITCHING POPUP NOISE CANCELLATION APPARATUS AND METHOD FOR A PORTABLE TERMINAL

(75) Inventors: Soo-Hyung KIM, Suwong-si (KR); Hoon-Do Heo, Suwon-si (KR); Jung-Hyeong Lee, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/831,711

(22) Filed: Jul. 31, 2007

(30) Foreign Application Priority Data
Aug. 29, 2006 (KR) 2006-82051

(51) Int. Cl. H04B 15/00

(52) U.S. Cl. 381/94.5

(57) ABSTRACT

A popup noise cancellation apparatus and method for a portable terminal having a switch selectively connecting one of a plurality of sound sources to a speaker are provided. The popup noise cancellation apparatus includes a first resistor grounded on a first link electrically connecting a first sound source and the switch; a first capacitor installed on the first link between the first sound source and the first resistor; a second resistor grounded on a second link electrically connecting the first sound source and the switch; a second capacitor installed on the second link between the first sound source and the second resistor; a third resistor grounded on a third link electrically connecting a second sound source and the switch; a third capacitor installed on the third link between the second sound source and the third resistor; a fourth resistor grounded on a fourth link electrically connecting the second sound source and the switch; and a fourth capacitor installed on the fourth link between the second sound source and the fourth resistor.

### PRIORITY

This application claims priority under 35 U.S.C. § 119 to an application entitled “SWITCHING POPUP NOISE CANCELLATION APPARATUS AND METHOD FOR PORTABLE TERMINAL” filed in the Korean Intellectual Property Office on Aug. 29, 2006 and assigned Serial No. 2006-82051, the contents of which are incorporated herein by reference.

### BACKGROUND OF THE INVENTION

1. Field of the Invention

The present invention relates generally to a portable terminal and, in particular, to a popup noise cancellation apparatus and method for a portable terminal.

2. Description of the Related Art

A modem chip of a typical portable terminal or a terminal is a unique sound source such that a popup noise generated by voltage differences in accordance with an operation of a codec is a target noise to be removed. Recent portable terminals have been developed with multiple sound sources that can be heard through an earphone jack. Such a portable terminal that has multiple sound sources is likely to generate a popup noise when switching the sound sources in addition to the popup noise caused by the coder/decoder (codec) operation.

FIG. 1 is a block diagram illustrating a conventional multi-sound source portable terminal, which includes a computer 103 as a sound source in addition to a modem 101, and in which the modem 101 and computer 103 are electrically connected to an earphone jack 107 through a switch 105.

In this configuration, the switch 105 selectively connects one of the modem 101 and the computer 103 according to a switch control signal 104 provided through a control node such that an audio signal created at the selected sound source is output to the earphone jack 107. When switching between sound sources, a popup noise is generated.

In order to remove such popup noises, a software-supported noise cancellation method has been provided. In this method, the software controls operation times of sound sources and the switch 105.

However, the conventional software-supported noise cancellation method does not remove the popup noise created when switching between multiple sound sources operating at different voltage levels.

### SUMMARY OF THE INVENTION

The present invention has been made in an effort to solve the at least above mentioned problems, and it is an object of the present invention to provide a switching popup noise cancellation apparatus and method for a portable terminal having multiple sound sources, that are capable of removing a popup noise created when switching between sound sources.

In accordance with an aspect of the present invention, a portable terminal includes a plurality of sound sources; a speaker for outputting audio signals generated by the sound sources; a switch for selectively connecting one of the sound sources to the speaker; and a noise canceller interposed between the switch and the sound sources for minimizing a difference between output voltages of the sound sources while switching the sound sources.

Preferably, the sound sources include a modem and a computer.

Preferably, the noise canceller includes a first resistor grounded on a first link electrically connecting the modem and the switch; a first capacitor installed on the first link between the modem and the first resistor; a second resistor grounded on a second link electrically connecting the modem and the switch; a second capacitor installed on the second link between the modem and the second resistor; a third resistor grounded on a third link electrically connecting the computer and the switch; a third capacitor installed on the third link between the computer and the third resistor; a fourth resistor grounded on a fourth link electrically connecting the computer and the switch; and a fourth capacitor installed on the fourth link between the computer and the fourth resistor.

In accordance with another aspect of the present invention, a noise canceller for a portable terminal having a switch selectively connecting one of a plurality of sound sources to a speaker is provided. The noise canceller includes a first resistor grounded on a first link electrically connecting a first sound source and the switch; a first capacitor installed on the first link between the first sound source and the first resistor; a second resistor grounded on a second link electrically connecting the first sound source and the switch; a second capacitor installed on the second link between the first sound source and the second resistor; a third resistor grounded on a third link electrically connecting a second sound source and the switch; a third capacitor installed on the third link between the second sound source and the third resistor; a fourth resistor grounded on a fourth link electrically connecting the second sound source and the switch; and a fourth capacitor installed on the fourth link between the second sound source and the fourth resist.

In accordance with another aspect of the present invention, there is provided a noise cancellation method for a portable terminal having a switch selectively connecting one of a plurality of sound sources to a speaker. The noise cancellation method includes connecting a first sound source to the speaker upon turning on the portable terminal; monitoring an input of a switching request signal; decreasing if a switching request signal is input, an output voltage of the first sound source to a ground level; disconnecting the first sound source from the speaker; and connecting a second sound source to the speaker.

Preferably, decreasing an output voltage of the first sound source is performed by at least a pull down resistor interposed between the first sound source and the speaker.

Preferably, the noise cancellation method further includes applying Direct Current (DC) coupling to signals output from the sound sources.

### BRIEF DESCRIPTION OF THE DRAWINGS

The above and other objects, features and advantages of the present invention will be more apparent from the following detailed description in conjunction with the accompanying drawings, in which:

FIG. 1 is a block diagram illustrating a configuration of a conventional multi-sound source portable terminal;

FIG. 2 is a block diagram illustrating a configuration of a portable terminal equipped with a switching popup noise cancellation circuit according to the present invention;

FIG. 3A is a graph illustrating audio signals on sound links of a portable terminal not equipped with the switching popup noise cancellation;

FIG. 3B is a graph illustrating audio signals on sound links of a portable terminal equipped with the conventional popup noise cancellation apparatus; and

FIG. 3C is a graph illustrating audio signals on sound links of a portable terminal equipped with the switching popup noise cancellation apparatus according to the present invention together with the software-supported noise cancellation.

### DETAILED DESCRIPTION OF PREFERRED EMBODIMENTS

Preferred embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

While the present invention can be embodied in many different forms, specific embodiments of the present invention are shown in drawings and will be described herein in detail, with the understanding that the present disclosure is to be considered as an exemplification of the principles of the invention and is not intended to limit the present invention to the specific embodiments illustrated.

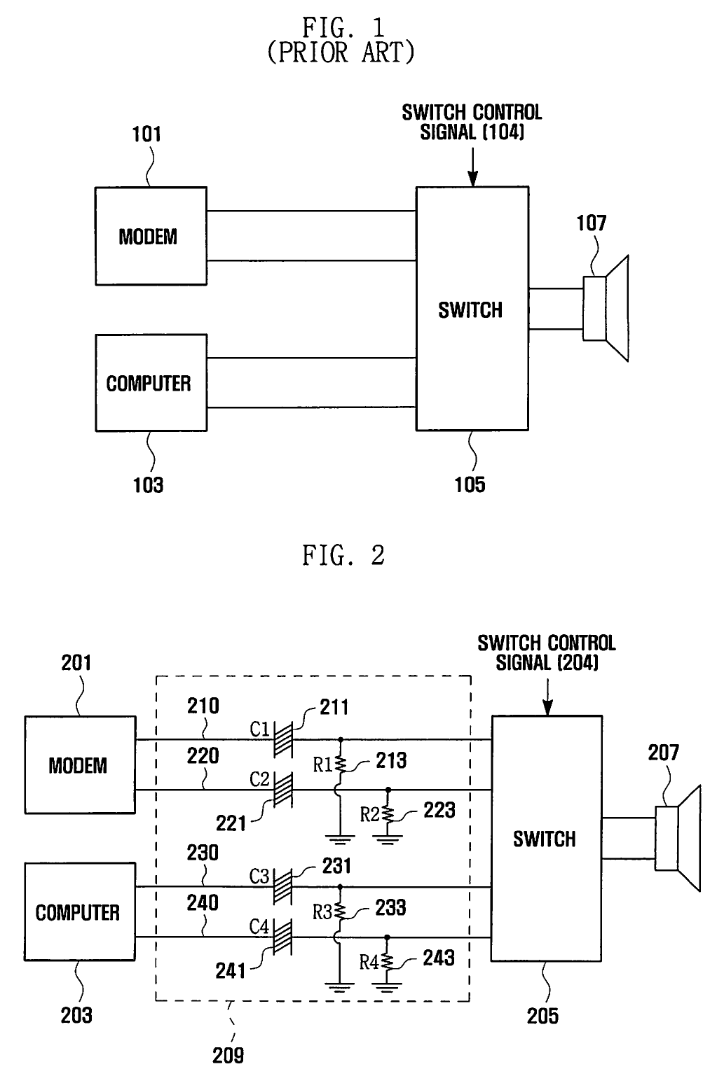

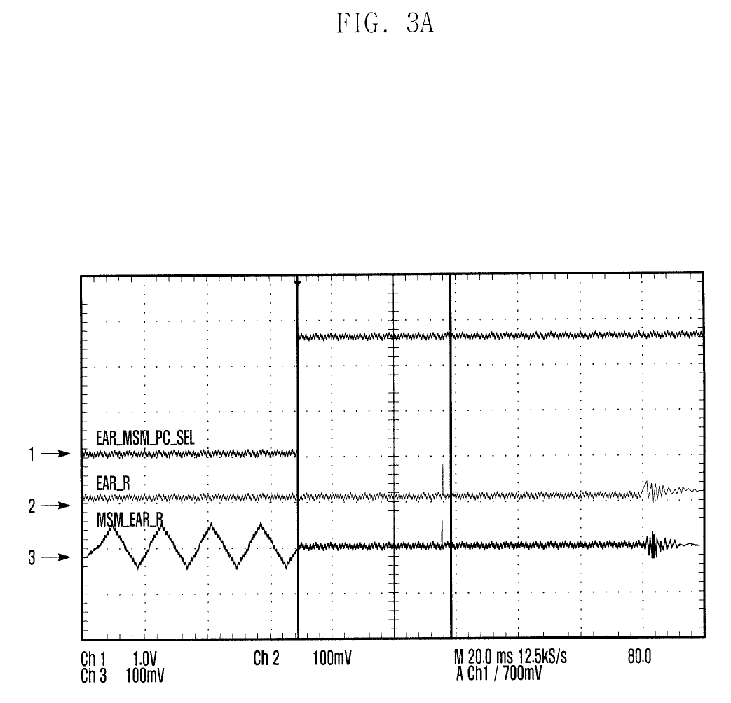

FIG. 2 is a block diagram illustrating a configuration of a portable terminal equipped with a switching popup noise cancellation circuit according to of the present invention.

Referring to FIG. 2, the portable terminal includes a modem 201 and computer 203 as sound sources, an earphone jack 207 connected to the modem 201 and the computer 203, and a switch 205 interconnecting the earphone jack 207 to the modem 201 and the computer 203. The switch 205 is connected to the modem 201 and the computer 203 through different links and connected to the earphone jack 207 through a common link.

In the present invention, the modem 201 and the computer 203 are depicted as the sound sources, however the sound sources and the number of the sound sources can be changed according to a type and purposes of the portable terminal.

The modem 201 is connected to the switch 205 through a first and a second sound link 210 and 220 in parallel, and the computer 202 is connected to the switch 205 through a third and a fourth sound link 230 and 240 in parallel.

Between the switch 205 and both the modem 201 and the computer 203, a noise cancellation circuit 209 is interposed.

The noise cancellation circuit 209 includes a first capacitor 211 installed on the first sound link 210, a first resistor 213 grounded between the first capacitor 211 and the switch 205, a second capacitor 221 installed on the second sound link 220, a second resistor 223 grounded between the second capacitor 221 and the switch 205, a third capacitor 231 installed on the third sound link 230, a third resistor 233 grounded between the third capacitor 231 and the switch 205, a fourth capacitor 241 installed on the fourth sound link 240, and a fourth resistor 243 grounded between the fourth capacitor 241 and the switch 205.

The first to fourth resistors 213, 223, 233, and 243 are grounded so as to remove the popup noise that is created when switching the sound sources in a case that audio signal levels on any of the first to fourth sound links are higher than a ground level.

An operation of the above-structured switching popup noise cancellation apparatus of the present invention is described below herein.

Referring to FIG. 2, the switch 205 connects the computer 203 and the earphone jack 207 in normal state so as to output the audio signals generated by the computer to the earphone jack 207. If a switch control signal 204 for switching the sound source is input through a control node while outputting the audio signals from the computer 203, the switch 205 releases the connection between the computer 203 and the earphone jack 207 and establishes a connection between the modem 201 and the earphone jack 207. In this case, a voltage difference between output nodes of the modem 201 and the computer 203 exists, which is the cause of the popup noise.

In the present invention, the first and second resistors 213 and 223 (pull down resistors) installed on the respective first and second sound links 210 and 220 decrease the voltage to the ground levels on the first and second sound links 210 and 220 to avoid the creation of the popup noise when switching the sound sources.

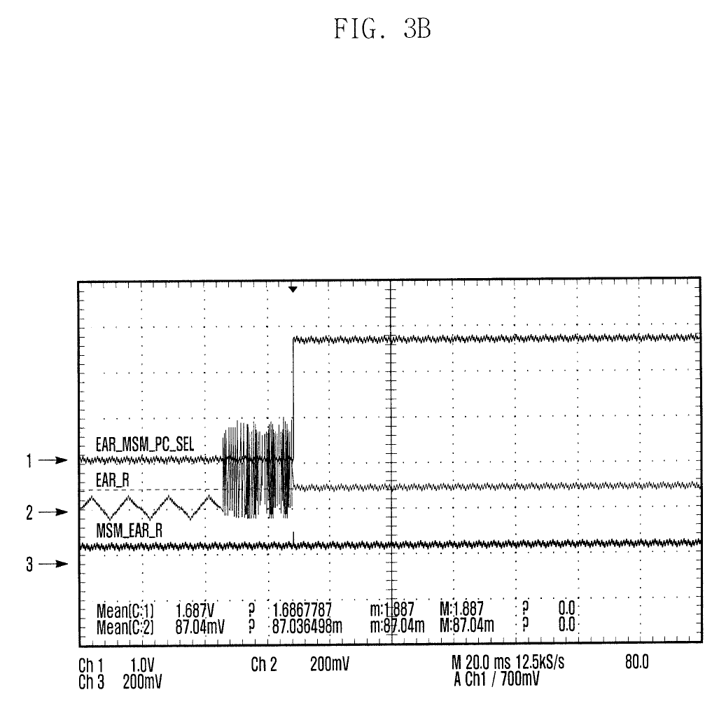

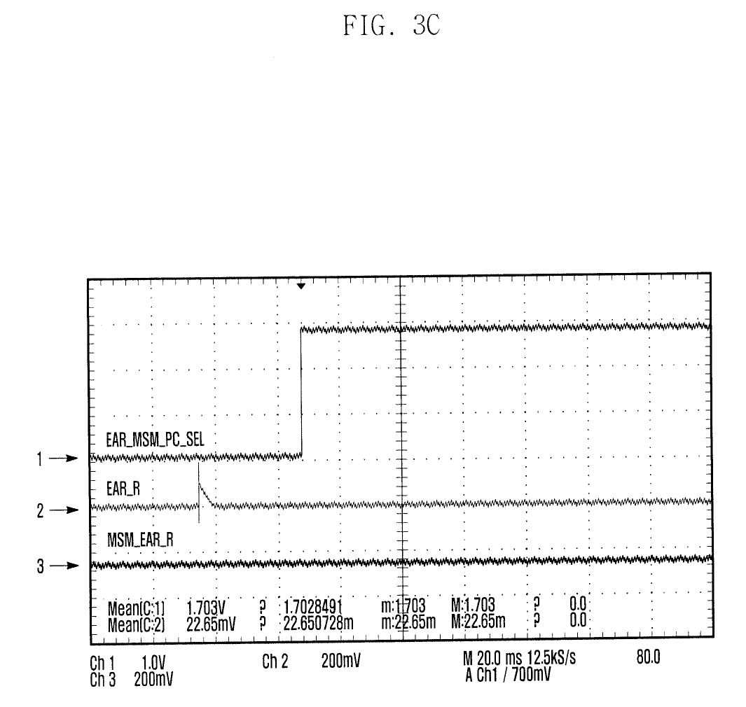

FIG. 3A is a graph illustrating audio signals on sound links of a portable terminal not equipped with the switching popup noise cancellation, FIG. 3B is a graph illustrating audio signals on sound links of a portable terminal equipped with the conventional popup noise cancellation apparatus, and FIG. 3C is a graph illustrating audio signals on the sound links of the portable terminal equipped with the switching popup noise cancellation apparatus according to the present invention together with the software-supported noise cancellation.

As shown in FIG. 3A, a popup noise is created when a codec of a modem is activated. In FIG. 3B, an activation time of the codec is adjusted by popup noise cancellation software such that no popup noise caused by the codec activation can be seen, however another popup noise can be seen when the sound source is switched to another sound source. In FIG. 3C, however, no popup noise can be seen since the codec activation related noise is cancelled by the software-supported popup nose cancellation technique and the noise caused when switching the sound source is cancelled by the switching popup noise cancellation technique of the present invention.

As described above, the switching popup noise cancellation apparatus and method minimizes a voltage difference between output links of two sound sources when switching the sound source, such that it is possible to avoid a popup noise from being created.

Although exemplary embodiments of the present invention have been described in detail hereinabove, it should be clearly understood that many variations and modifications of the basic inventive concepts taught herein which may appear to those skilled in the present art will still fall within the spirit and scope of the present invention, as defined in the appended claims.

What is claimed is:

1. A portable terminal comprising:
a plurality of sound sources;
a speaker for outputting audio signals generated by the sound sources;
a switch for selectively connecting one of the sound sources to the speaker; and
a noise canceller interposed between the switch and the sound sources for minimizing a difference between output voltages of the sound sources while switching the sound sources.

2. The portable terminal of claim 1, wherein the sound sources comprise a modem and a computer.

3. The portable terminal of claim 2, wherein the noise canceller comprises:
a first resistor grounded on a first link electrically connecting the modem and the switch;
a first capacitor installed on the first link between the modem and the first resistor;
a second resistor grounded on a second link electrically connecting the modem and the switch;
a second capacitor installed on the second link between the modem and the second resistor;
a third resistor grounded on a third link electrically connecting the computer and the switch;
a third capacitor installed on the third link between the computer and the third resistor;
a fourth resistor grounded on a fourth link electrically connecting the computer and the switch; and
a fourth capacitor installed on the fourth link between the computer and the fourth resistor.

4. A noise canceller for a portable terminal having a switch selectively connecting one of a plurality of sound sources to a speaker, comprising:
a first resistor grounded on a first link electrically connecting a first sound source and the switch;
a first capacitor installed on the first link between the first sound source and the first resistor;
a second resistor grounded on a second link electrically connecting the first sound source and the switch;
a second capacitor installed on the second link between the first sound source and the second resistor;
a third resistor grounded on a third link electrically connecting a second sound source and the switch;
a third capacitor installed on the third link between the second sound source and the third resistor;
a fourth resistor grounded on a fourth link electrically connecting the second sound source and the switch; and
a fourth capacitor installed on the fourth link between the second sound source and the fourth resistor.

5. A noise cancellation method for a portable terminal having a switch selectively connecting one of a plurality of sound sources to a speaker, comprising:
connecting a first sound source to the speaker upon turning on the portable terminal;
detecting an input of a switching request signal;
decreasing, if a switching request signal is detected, an output voltage of the first sound source to a ground level;
disconnecting the first sound source from the speaker; and
connecting a second sound source to the speaker.

6. The noise cancellation method of claim 5, wherein decreasing an output voltage of the first sound source is performed by at least a pull down resistor interposed between the first sound source and the speaker.

7. The noise cancellation method of claim 6 further comprising applying Direct Current (DC) coupling to signals output from the sound sources.
